(19) United States
(12) Patent Application Publication
(10) Pub. No.: US 2024/0405231 A1
(43) Pub. Date: Dec. 5, 2024

(54) SYSTEMS AND METHODS FOR A FLOW FIELD PLATE DESIGN FOR POLYMER-ELECTROLYTE-MEMBRANE FUEL CELLS

(71) Applicant: Toyota Motor Engineering & Manufacturing North America, Inc., Plano, TX (US)

(72) Inventors: Yuqing Zhou, Ann Arbor, MI (US); Danny J. Lohan, Northville, MI (US); Ercan M. Dede, Ann Arbor, MI (US); Feng Zhou, Ann Arbor, MI (US); Hiroshi Ukegawa, South Lyon, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/327,664

(22) Filed: Jun. 1, 2023

(51) Int. Cl. H01M 8/0265; H01M 8/0267; H01M 8/241

(52) U.S. Cl. CPC H01M 8/0265; H01M 8/0267; H01M 8/241

(57) ABSTRACT

A method, computer program product, and bipolar plate structure for a fuel cell stack inside a polymer-electrolyte-membrane (PEM) fuel cell stack. The bipolar plate structure may be created, wherein creating the bipolar plate structure may include forming a z-shaped pattern for a plurality of hydrogen flow channels. Creating the bipolar plate structure may include forming a z-shaped pattern for a plurality of air flow channels. Creating the bipolar plate structure may include forming an x-shaped crossing pattern for a plurality of coolant flow channels.

### BACKGROUND

Bipolar plates are core components inside polymer-electrolyte-membrane (PEM) fuel cell stacks. Generally, the surface of the bipolar plate has a flow field for the distribution and transmission of, e.g., hydrogen, air, and reaction products, which is also known as the flow field plate. The coolant may be passed through a separate flow field integrated with two adjacent plates. For plates formed by conventional stamping processes, the coolant domain is typically formed by the back sides of two adjacent plates. Such integrated cooling runners may reduce size and cost of fuel cell stacks.

### BRIEF SUMMARY OF DISCLOSURE

In one example implementation, a method, performed by one or more computing devices, may include but is not limited to creating a bipolar plate structure for a fuel cell stack inside a polymer-electrolyte-membrane (PEM) fuel cell stack. Creating the bipolar plate structure may include forming a z-shaped pattern for a plurality of hydrogen flow channels. Creating the bipolar plate structure may include forming a z-shaped pattern for a plurality of air flow channels. Creating the bipolar plate structure may include forming an x-shaped crossing pattern for a plurality of coolant flow channels.

One or more of the following example features may be included. The plurality of hydrogen flow channels may be parallel to the plurality of air flow channels in a center portion of the bipolar plate structure. The plurality of hydrogen flow channels may be tilted in a first direction, wherein the plurality of air flow channels may be tilted in a second direction, and wherein the first direction and the second direction may be opposite directions. The plurality of hydrogen flow channels, the plurality of air flow channels, and the plurality of coolant flow channels may flow horizontally in terms of their inlet/outlet locations. An inlet of the bipolar plate structure for the plurality of hydrogen flow channels may be located on an opposite side of the bipolar plate structure than an inlet of the bipolar plate structure for the plurality of air flow channels. The inlet of the bipolar plate structure for the plurality of air flow channels may be on a same side of the bipolar plate structure as an inlet of the bipolar plate structure for the plurality of coolant flow channels. Each flow channel of the plurality of hydrogen flow channels may be a singular z-shape spanning a first edge of the bipolar plate structure to a second edge of the bipolar plate structure, and wherein each flow channel of the plurality of air flow channels may be a singular z-shape spanning the first edge of the bipolar plate structure to the second edge of the bipolar plate structure.

In another example implementation, a computing system may include one or more processors and one or more memories configured to perform operations that may include but are not limited to creating a bipolar plate structure for a fuel cell stack inside a polymer-electrolyte-membrane (PEM) fuel cell stack. Creating the bipolar plate structure may include forming a z-shaped pattern for a plurality of hydrogen flow channels. Creating the bipolar plate structure may include forming a z-shaped pattern for a plurality of air flow channels. Creating the bipolar plate structure may include forming an x-shaped crossing pattern for a plurality of coolant flow channels.

One or more of the following example features may be included. The plurality of hydrogen flow channels may be parallel to the plurality of air flow channels in a center portion of the bipolar plate structure. The plurality of hydrogen flow channels may be tilted in a first direction, wherein the plurality of air flow channels may be tilted in a second direction, and wherein the first direction and the second direction may be opposite directions. The plurality of hydrogen flow channels, the plurality of air flow channels, and the plurality of coolant flow channels may flow horizontally in terms of their inlet/outlet locations. An inlet of the bipolar plate structure for the plurality of hydrogen flow channels may be located on an opposite side of the bipolar plate structure than an inlet of the bipolar plate structure for the plurality of air flow channels. The inlet of the bipolar plate structure for the plurality of air flow channels may be on a same side of the bipolar plate structure as an inlet of the bipolar plate structure for the plurality of coolant flow channels. Each flow channel of the plurality of hydrogen flow channels may be a singular z-shape spanning a first edge of the bipolar plate structure to a second edge of the bipolar plate structure, and wherein each flow channel of the plurality of air flow channels may be a singular z-shape spanning the first edge of the bipolar plate structure to the second edge of the bipolar plate structure.

In another example implementation, a computer program product may reside on a computer readable storage medium having a plurality of instructions stored thereon which, when executed across one or more processors, may cause at least a portion of the one or more processors to perform operations that may include but are not limited to creating a bipolar plate structure for a fuel cell stack inside a polymer-electrolyte-membrane (PEM) fuel cell stack. Creating the bipolar plate structure may include forming a z-shaped pattern for a plurality of hydrogen flow channels. Creating the bipolar plate structure may include forming a z-shaped pattern for a plurality of air flow channels. Creating the bipolar plate structure may include forming an x-shaped crossing pattern for a plurality of coolant flow channels.

One or more of the following example features may be included. The plurality of hydrogen flow channels may be parallel to the plurality of air flow channels in a center portion of the bipolar plate structure. The plurality of hydrogen flow channels may be tilted in a first direction, wherein the plurality of air flow channels may be tilted in a second direction, and wherein the first direction and the second direction may be opposite directions. The plurality of hydrogen flow channels, the plurality of air flow channels, and the plurality of coolant flow channels may flow horizontally in terms of their inlet/outlet locations. An inlet of the bipolar plate structure for the plurality of hydrogen flow channels may be located on an opposite side of the bipolar plate structure than an inlet of the bipolar plate structure for the plurality of air flow channels. The inlet of the bipolar plate structure for the plurality of air flow channels may be on a same side of the bipolar plate structure as an inlet of the bipolar plate structure for the plurality of coolant flow channels. Each flow channel of the plurality of hydrogen flow channels may be a singular z-shape spanning a first edge of the bipolar plate structure to a second edge of the bipolar plate structure, and wherein each flow channel of the plurality of air flow channels may be a singular z-shape spanning the first edge of the bipolar plate structure to the second edge of the bipolar plate structure.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of a stacking configuration of stamped flow field plates;

FIG. 2 is an example diagrammatic view of a flow channel design of a stacking configuration of stamped flow field plates;

FIG. 3 is an example diagrammatic view of a flow channel design of a stacking configuration of stamped flow field plates;

FIG. 4 is an example flowchart of a bipolar plate structure process according to one or more example implementations of the disclosure;

FIG. 5 is an example diagrammatic view of a flow channel design of a stacking configuration of stamped flow field plates according to one or more example implementations of the disclosure;

FIG. 6 is an example diagrammatic view of a flow channel design of a stacking configuration of stamped flow field plates according to one or more example implementations of the disclosure; and

FIG. 7 is an example chart showing flow uniformity at the center of the coolant layer for a stacking configuration of stamped flow field plates according to one or more example implementations of the disclosure.

Like reference symbols in the various drawings may indicate like elements.

### DETAILED DESCRIPTION

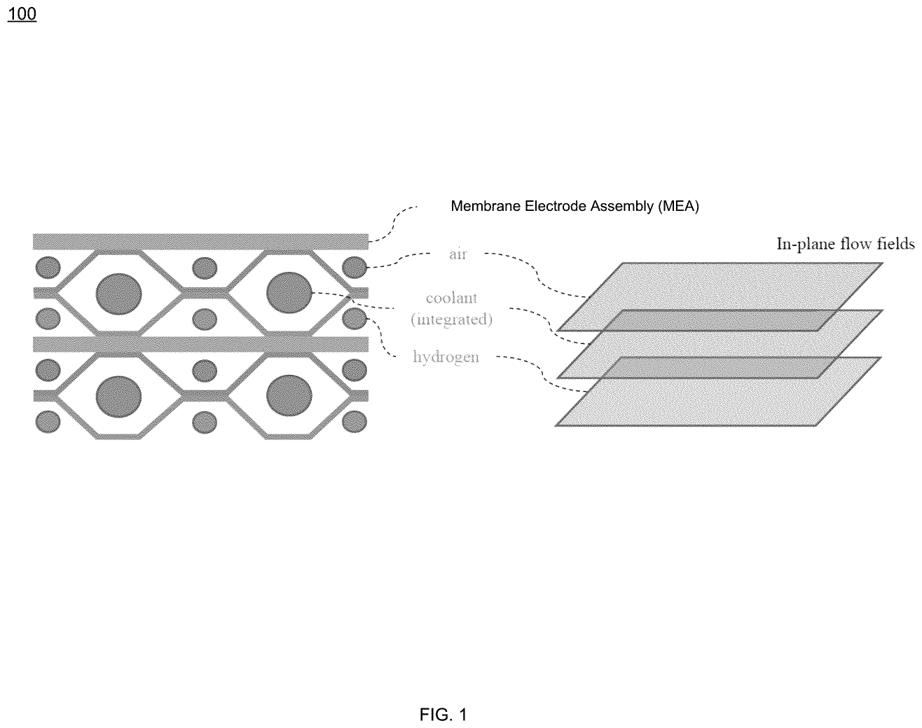

As noted above, bipolar plates are core components inside polymer-electrolyte-membrane (PEM) fuel cell stacks. Generally, the surface of the bipolar plate has a flow field for the distribution and transmission of, e.g., hydrogen, air, and reaction products, which is also known as the flow field plate. The coolant may be passed through a separate flow field integrated with two adjacent plates. For plates formed by conventional stamping processes, the coolant domain is typically formed by the back sides of two adjacent plates. Such integrated cooling runners may reduce the size and the cost of fuel cell stacks. An example of a typical stacking configuration 100 of stamped flow field plates is shown in FIG. 1.

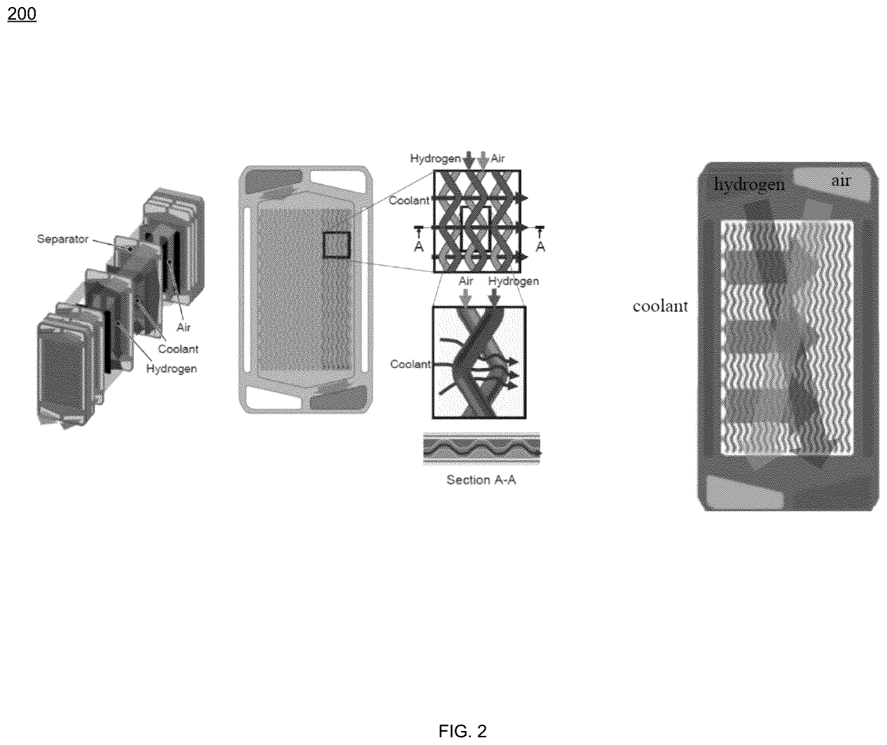

Some fuel cell stacks, such as the flow channel design 200 of a fuel cell stack shown in example FIG. 2, employ wave channel flow separators to help ensure a uniform supply of hydrogen, oxygen, and coolant. Wave channels from both the air and hydrogen layers also create crossing coolant flow patterns, which is beneficial for thermal management due to local disruptions. However, it has been discovered that wave channels suffer from 1) higher pressure drops compared with straight parallel channels, and 2) localized strain defects after stamping. While making the coolant flow direction orthogonal to the air and hydrogen flow direction enables the width of the supply paths for both gases and coolant to be increased (which helps with the uniform distribution), such a configuration tends to increase the overall footprint and volume of the stack assembly.

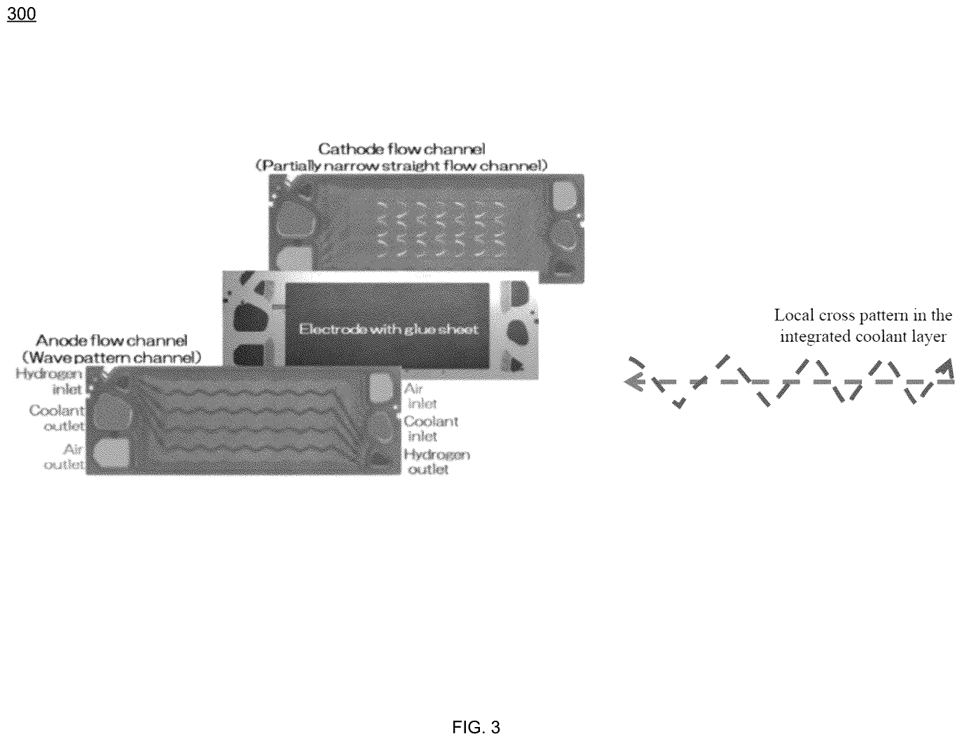

Some fuel cell stacks, such as the flow channel design 300 of a fuel cell stack shown in example FIG. 3, employ horizontal parallel channels for the air supply (e.g., cathode) and wave channels for the hydrogen supply (e.g., anode). As a result, the integrated coolant flow field generates the local crossing pattern within neighboring channels for enhanced thermal management. However, similarly with the design shown in FIG. 2, wave channels suffer from 1) a higher pressure drop compared with straight parallel channels and 2) localized strain defects after stamping. It is also noted that this configuration may make air, hydrogen, and coolant all flow horizontally, which may reduce the width of their inlet/outlet supply path and may impede uniform supply.

Therefore, as will be discussed in greater detail below, the present disclosure describes a unique in-plane flow channel design strategy for all three layers, based on the geometrically coupled stacking configuration (when assuming sheet metal stamping plates). The example flow channel design may ensure that a uniform fluid flow is generated in the flow field under reasonable pressure drop, so that the reactants may be reasonably diffused and distributed to the electrodes. The heat and water generated by the electrochemical reactions may be effectively removed to maintain the required temperature and humidity conditions.

### The Bipolar Plate Structure Process:

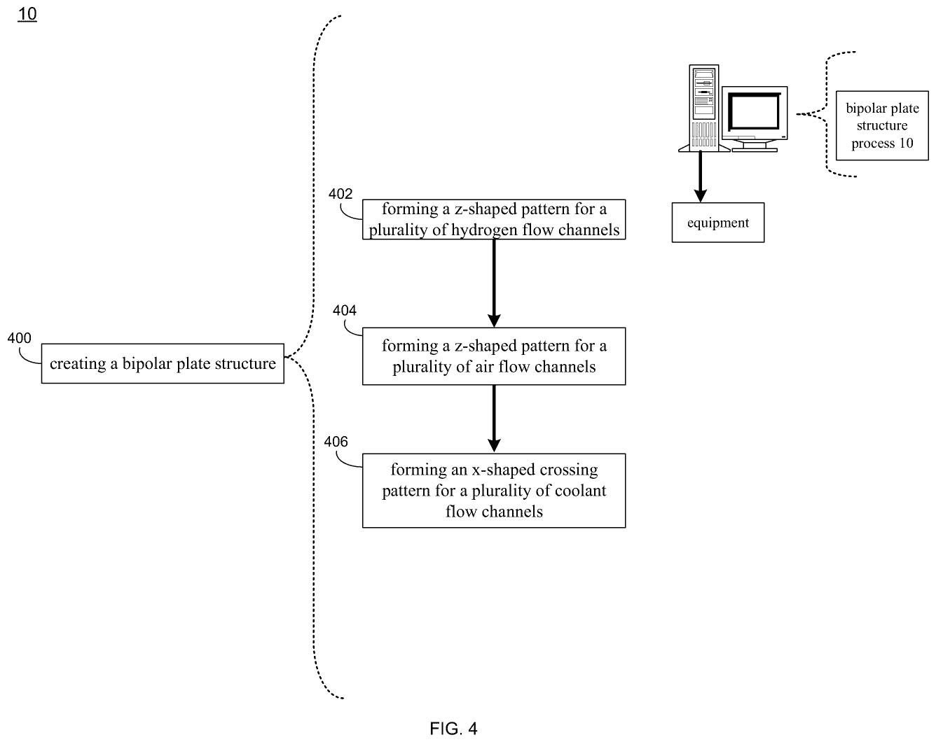

As discussed above and referring also at least to the example implementations of FIGS. 4-7, bipolar plate structure (BPS) process 10 may create 400 a bipolar plate structure for a fuel cell stack inside a polymer-electrolyte-membrane (PEM) fuel cell stack. Creating the bipolar plate structure may include BPS process 10 forming 402 a z-shaped pattern for a plurality of hydrogen flow channels. Creating the bipolar plate structure may include BPS process 10 may include forming 404 a z-shaped pattern for a plurality of air flow channels. Creating the bipolar plate structure may include BPS process 10 may include forming 406 an x-shaped crossing pattern for a plurality of coolant flow channels.

In some implementations, BPS process 10 may create 400 a bipolar plate structure for a fuel cell stack inside a polymer-electrolyte-membrane (PEM) fuel cell stack. For example, using any known manufacturing techniques (e.g., such as stamping), BPS process 10 may use equipment to create 400 the bipolar plate structure for the fuel cell stack inside the PEM fuel cell stack.

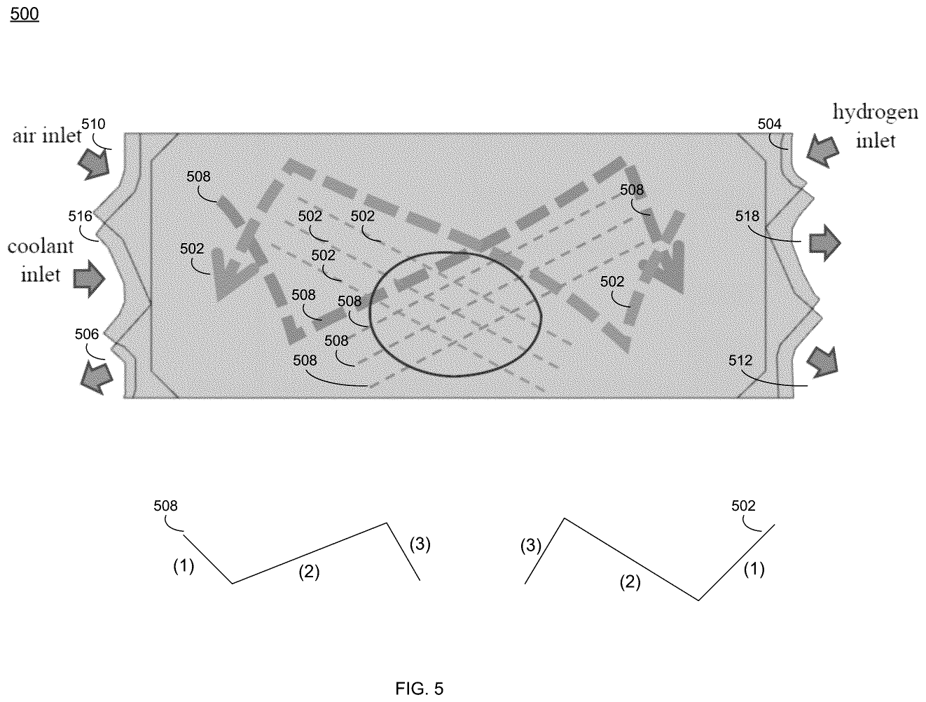

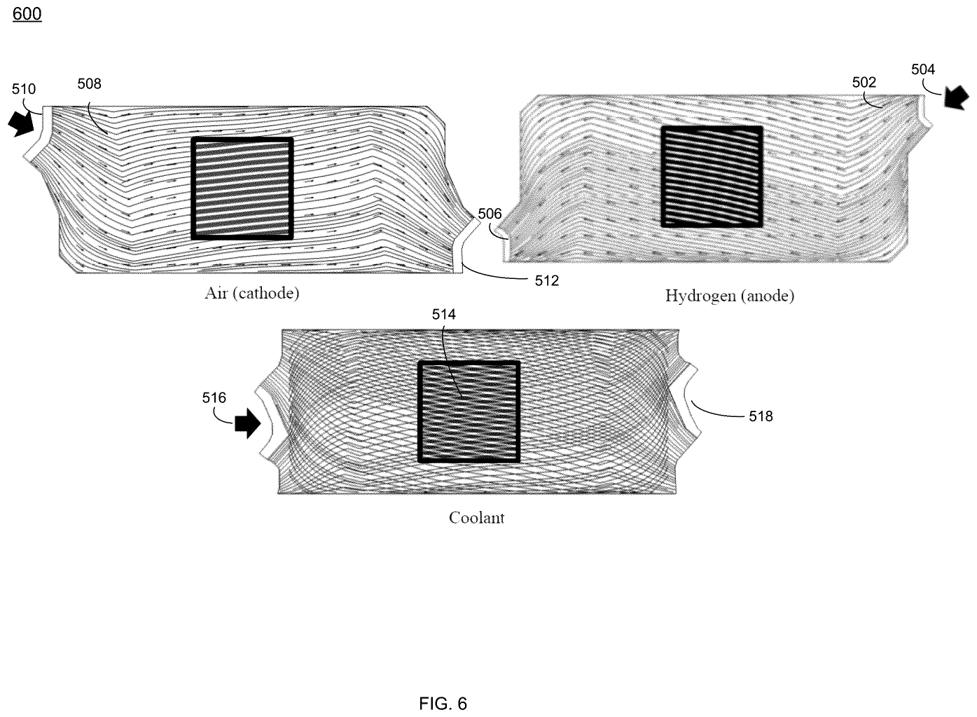

In some implementations, creating the bipolar plate structure may include BPS process 10 forming 402 a z-shaped pattern for a plurality of hydrogen flow channels. For instance, and referring at least to the example implementation of FIG. 5 and FIG. 6, an example flow field design 500 of flow field plates, and a representative flow channel design 600 for air (cathode), hydrogen (anode), and coolant layers) are shown respectively to disclose one example representative design for air, hydrogen, and coolant flow field plates. In the example, there are shown hydrogen flow channels (e.g., hydrogen flow channels 502). As can be seen in FIGS. 5 and 6, there is a z-shaped pattern created by hydrogen flow channels 502. In some implementations, the z-shaped pattern may include, from the hydrogen inlet (e.g., hydrogen inlet 504), (1) a first downward left direction portion, then (2) an upward left direction portion, followed by (3) a second downward left direction portion to the hydrogen outlet (e.g., hydrogen outlet 506). For clarity, only the thicker dashed line of hydrogen flow channel 502 shows the full z-shaped pattern, but it will be appreciated that the thinner dashed lines of hydrogen flow channel 502 follow a similar pattern, as shown in FIG. 6. It will be appreciated that while each of the three portions making up the z-shape pattern may appear completely straight, there may also be at least some curvature to at least some of the three portions.

In some implementations, creating the bipolar plate structure may include BPS process 10 forming 404 a z-shaped pattern for a plurality of air flow channels. For instance, and still referring to FIGS. 5 and 6, there are shown air flow channels (e.g., air flow channels 508). As can be seen in FIG. 5, there is a z-shaped pattern created by air flow channels 508. In some implementations, the pattern may include, from the air inlet (e.g., air inlet 510), (1) a first downward right direction portion, then (2) an upward right direction portion, followed by (3) a second downward right direction portion to the air outlet (e.g., air outlet 512). Notably, this is the opposite/mirrored z-shape pattern of the hydrogen flow channel. For clarity, only the thicker dashed line of air flow channel 508 shows the full z-shaped pattern, but it will be appreciated that the thinner dashed lines of air flow channel 508 follow a similar pattern, as shown in FIG. 6. It will be appreciated that while each of the three portions making up the z-shape pattern may appear completely straight, there may also be at least some curvature to at least some of the three portions.

In some implementations, creating the bipolar plate structure may include BPS process 10 forming 406 an x-shaped crossing pattern for a plurality of coolant flow channels. For instance, and still referring to FIGS. 5 and 6, there are shown coolant flow channels (e.g., coolant flow channels 514). As can be seen in FIG. 5, there is an x-shaped pattern created by coolant flow channels 514. In some implementations, the pattern may include a beginning, from the coolant inlet (e.g., coolant inlet 516) to an ending at the coolant outlet (e.g., coolant outlet 518). As shown, the coolant flow channels have long, straight, parallel central channel portions combining to form the x-shaped crossing pattern with the z-shaped patterns of the hydrogen and air flow channels.

In some implementations, the plurality of hydrogen flow channels may be tilted in a first direction, wherein the plurality of air flow channels may be tilted in a second direction, and wherein the first direction and the second direction may be opposite directions. For instance, straight parallel channels may be used for both the air (i.e., cathode) and hydrogen (i.e., anode) flow field plates slightly tilted (in opposite directions) That is, the z-shape pattern of the air flow channel is the opposite/mirrored z-shape pattern of the hydrogen flow channel. Due to the unique angled parallel configuration, the resulting coolant flow field naturally generates a global crossing pattern, which may be beneficial for effective thermal management. Due to the elimination of wave channels, the pressure drops may be low for all three flow fields. The angled parallel configuration may also help with the air and hydrogen flow uniformity, as more flow may be effectively guided to the far side of their respective inlet locations.

In some implementations, each flow channel of the plurality of hydrogen flow channels may be a singular z-shape spanning a first edge of the bipolar plate structure (e.g., the edge with hydrogen inlet 504) to a second edge of the bipolar plate structure (e.g., the edge with hydrogen outlet 506), and wherein each flow channel of the plurality of air flow channels may be a singular z-shape spanning the first edge of the bipolar plate structure (e.g., the edge with air inlet 510) to the second edge of the bipolar plate structure (e.g., the edge with air outlet 512). That is, unlike designs with flow channels in the shape of repeating “waves”, the example implementation shown in FIGS. 5 and 6 shows, from hydrogen inlet 504, a first downward left direction, then an upward left direction, followed by a second downward left direction to hydrogen outlet 506, making a singular z-shape (for each individual channel) spanning hydrogen inlet 504 to hydrogen outlet 506. Similarly, from air inlet 510, a first downward right direction, then an upward right direction, followed by a second downward right direction to air outlet 512, making a singular z-shape (for each individual channel) spanning air inlet 510 to air outlet 512.

In some implementations, the overall plate size dimension may be, e.g., between 300-500 mm in length and 100-200 mm in width. However, it will be appreciated that other lengths and widths may be used for the overall plate size dimensions without departing from the scope of the present disclosure. As such, the use of these dimensions should be taken as example only and not to otherwise limit the scope of the present disclosure.

In some implementations, the inlet of the bipolar plate structure for the plurality of air flow channels may be on a same side of the bipolar plate structure as an inlet of the bipolar plate structure for the plurality of coolant flow channels. For example, and still referring to FIGS. 5 and 6, it is shown that air flow channel inlet 510 is on the same side as coolant inlet 516. By having air and coolant inlets located on the same side, there is more effective cooling (i.e., more uniform temperature distribution across the domain). However, it will be appreciated that it may be the hydrogen flow channel inlet that is on the same side as coolant inlet 516, rather than the air flow channel inlet.

In some implementations, an inlet of the bipolar plate structure for the plurality of hydrogen flow channels may be located on an opposite side of the bipolar plate structure than an inlet of the bipolar plate structure for the plurality of air flow channels. For example, and still referring to FIGS. 5 and 6, it is shown that hydrogen flow channel inlet 504 is on the opposite side of air flow inlet 512. As such, inlets of air and hydrogen supplies may be located on the opposite sides of the plate while the coolant inlet may be located at the same side of the air inlet.

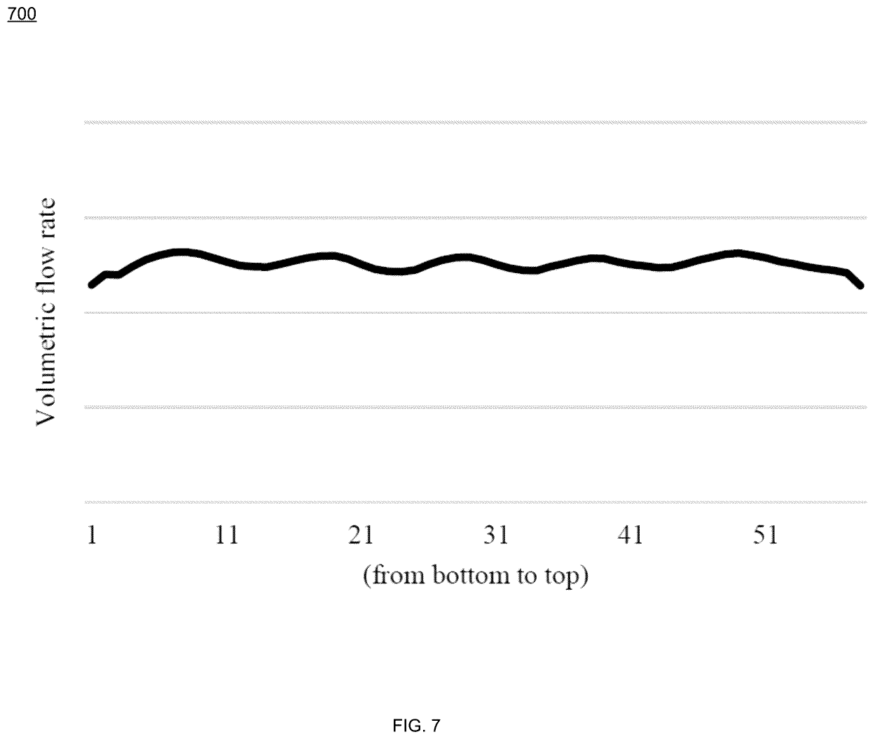

In some implementations, the plurality of hydrogen flow channels and the plurality of air flow channels may be each primarily parallel in a center portion of the bipolar plate structure. For instance, for both the air and the hydrogen flow fields, both follow a z-shaped pattern with a majority of channels being slightly tilted and parallel in the center. As a result, the coolant flow field may form an x-shaped pattern (shown in the circled center portion of FIG. 5 and the blown-up square portion of the coolant flow channels in FIG. 6) with sufficient global crossing for the enhanced thermal management behavior. For instance, thanks to the unique x-shaped crossing pattern formed in the coolant layer, the coolant flow may achieve, e.g., over ˜ 98% uniformity in the center of the plate, as shown the example flow uniformity chart 700 in FIG. 7.

In some implementations, the plurality of hydrogen flow channels, the plurality of air flow channels, and the plurality of coolant flow channels may flow horizontally. For instance, the designs of FIG. 5 and FIG. 6 result in gas flow (i.e., air and hydrogen) and coolant flow being horizontal to reduce the overall volumetric size of the stack.

Therefore, the present disclosure describes both air and hydrogen flow fields following a Z-shaped pattern, with long, straight, parallel portions of the flow having a majority of channels being slightly tilted and parallel in the center. Due to the elimination of wave channels used in previous designs (e.g., as shown in FIG. 2 and FIG. 3), the pressure drops may be significantly reduced in all three layers. Moreover, advantageously, it has been discovered that after stacking the air and hydrogen flow field plates with angled parallel channels, the coolant flow field forms an X-shaped pattern with sufficient local and global geometric crossing for the enhanced thermal management behavior and superior coolant flow uniformity.

It will be appreciated that any standard bipolar plate structure assembly/printing/fabrication/stamping, etc. equipment, as well as any other necessary equipment, may be used singly or in any combination with bipolar plate structure process 10, which may be operatively connected to a computing device, such as the computing device shown in FIG. 4, to obtain their instructions.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN), a wide area network (WAN), a body area network BAN), a personal area network (PAN), a metropolitan area network (MAN), etc., or the connection may be made to an external computer (for example, through the internet using an Internet Service Provider). In some implementations, electronic circuitry including, for example, programmable logic circuitry, an application specific integrated circuit (ASIC), field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A bipolar plate structure for a fuel cell stack inside a polymer-electrolyte-membrane (PEM) fuel cell stack comprising:
a bipolar plate structure, wherein the bipolar plate structure includes:
a z-shaped pattern for a plurality of hydrogen flow channels;
a z-shaped pattern for a plurality of air flow channels; and
an x-shaped crossing pattern for a plurality of coolant flow channels.

2. The bipolar plate structure of claim 1, wherein the plurality of hydrogen flow channels and the plurality of air flow channels are each parallel in a center portion of the bipolar plate structure.

3. The bipolar plate structure of claim 2, wherein the plurality of hydrogen flow channels is tilted in a first direction, wherein the plurality of air flow channels is tilted in a second direction, and wherein the first direction and the second direction are opposite directions.

4. The bipolar plate structure of claim 1, wherein the plurality of hydrogen flow channels, the plurality of air flow channels, and the plurality of coolant flow channels flow horizontally in terms of their inlet/outlet locations.

5. The bipolar plate structure of claim 1, wherein an inlet of the bipolar plate structure for the plurality of hydrogen flow channels is located on an opposite side of the bipolar plate structure than an inlet of the bipolar plate structure for the plurality of air flow channels.

6. The bipolar plate structure of claim 5, wherein the inlet of the bipolar plate structure for the plurality of air flow channels is on a same side of the bipolar plate structure as an inlet of the bipolar plate structure for the plurality of coolant flow channels.

7. The bipolar plate structure of claim 1, wherein each flow channel of the plurality of hydrogen flow channels is a singular z-shape spanning a first edge of the bipolar plate structure to a second edge of the bipolar plate structure, and wherein each flow channel of the plurality of air flow channels is a singular z-shape spanning the first edge of the bipolar plate structure to the second edge of the bipolar plate structure.

8. A computer program product residing on a computer readable storage medium having a plurality of instructions stored thereon which, when executed across one or more processors, causes at least a portion of the one or more processors to perform operations for creating a bipolar plate structure for a fuel cell stack inside a polymer-electrolyte-membrane (PEM) fuel cell stack comprising:
creating a bipolar plate structure, wherein creating the bipolar plate structure includes:
forming a z-shaped pattern for a plurality of hydrogen flow channels;
forming a z-shaped pattern for a plurality of air flow channels; and
forming an x-shaped crossing pattern for a plurality of coolant flow channels.

9. The computer program product of claim 8, wherein the plurality of hydrogen flow channels is parallel to the plurality of air flow channels in a center portion of the bipolar plate structure.

10. The computer program product of claim 9, wherein the plurality of hydrogen flow channels is tilted in a first direction, wherein the plurality of air flow channels is tilted in a second direction, and wherein the first direction and the second direction are opposite directions.

11. The computer program product of claim 8, wherein the plurality of hydrogen flow channels, the plurality of air flow channels, and the plurality of coolant flow channels flow horizontally in terms of their inlet/outlet locations.

12. The computer program product of claim 8, wherein an inlet of the bipolar plate structure for the plurality of hydrogen flow channels is located on an opposite side of the bipolar plate structure than an inlet of the bipolar plate structure for the plurality of air flow channels.

13. The computer program product of claim 12, wherein the inlet of the bipolar plate structure for the plurality of air flow channels is on a same side of the bipolar plate structure as an inlet of the bipolar plate structure for the plurality of coolant flow channels.

14. The computer program product of claim 8, wherein each flow channel of the plurality of hydrogen flow channels is a singular z-shape spanning a first edge of the bipolar plate structure to a second edge of the bipolar plate structure, and wherein each flow channel of the plurality of air flow channels is a singular z-shape spanning the first edge of the bipolar plate structure to the second edge of the bipolar plate structure.

15. A method for creating a bipolar plate structure for a fuel cell stack inside a polymer-electrolyte-membrane (PEM) fuel cell stack comprising:
creating a bipolar plate structure, wherein creating the bipolar plate structure includes:
forming a z-shaped pattern for a plurality of hydrogen flow channels;
forming a z-shaped pattern for a plurality of air flow channels; and
forming an x-shaped crossing pattern for a plurality of coolant flow channels.

16. The method of claim 15, wherein the plurality of hydrogen flow channels is parallel to the plurality of air flow channels in a center portion of the bipolar plate structure.

17. The method of claim 16, wherein the plurality of hydrogen flow channels is tilted in a first direction, wherein the plurality of air flow channels is tilted in a second direction, and wherein the first direction and the second direction are opposite directions.

18. The method of claim 15, wherein the plurality of hydrogen flow channels, the plurality of air flow channels, and the plurality of coolant flow channels flow horizontally in terms of their inlet/outlet locations.

19. The method of claim 15, wherein an inlet of the bipolar plate structure for the plurality of hydrogen flow channels is located on an opposite side of the bipolar plate structure than an inlet of the bipolar plate structure for the plurality of air flow channels.

20. The method of claim 15, wherein each flow channel of the plurality of hydrogen flow channels is a singular z-shape spanning a first edge of the bipolar plate structure to a second edge of the bipolar plate structure, and wherein each flow channel of the plurality of air flow channels is a singular z-shape spanning the first edge of the bipolar plate structure to the second edge of the bipolar plate structure.
